(19) United States
(12) Patent Application Publication
(10) Pub. No.: US 2023/0286028 A1
(43) Pub. Date: Sep. 14, 2023

(54) SURFACE REFORMING DEVICE AND METHOD THEREOF

(71) Applicant: NATIONAL TSING HUA UNIVERSITY, Hsinchu (TW)

(72) Inventors: Aniket Anil HASE, Hsinchu (TW); Jen-Yuan CHANG, Hsinchu (TW)

(21) Appl. No.: 17/810,645

(22) Filed: Jul. 5, 2022

(30) Foreign Application Priority Data
Mar. 10, 2022 (TW) 111108863

(51) Int. Cl. B23P 6/04

(52) U.S. Cl. CPC B23P 6/04

(57) ABSTRACT

A surface reforming device which is configured for reforming a surface of an article includes a frame body, a first shaping assembly, a second shaping assembly and a driving mechanism. The frame body includes two side plates and a supporting shaft. The first shaping assembly is located in the operating space and includes a first plate body, a plurality of first through holes, a plurality of first rods and a plurality of first rod locking mechanisms. The second shaping assembly is located in the operating space and includes a second plate body, a plurality of second through holes, a plurality of second rods and a plurality of second rod locking mechanisms. The driving mechanism is configured for driving the first shaping assembly and the second shaping assembly to move towards each other along a pushing direction perpendicular to the z-axis and press the article.

### RELATED APPLICATIONS

This application claims priority to Taiwan Application Serial Number 111108863, filed Mar. 10, 2022, which is herein incorporated by reference.

### BACKGROUND

### Technical Field

The present disclosure relates to a reforming device and a method thereof. More particularly, the present disclosure relates to a surface reforming device and a method thereof which can reform a surface of an article.

### Description of Related Art

In engineering productions, after the article such as a propeller has produced, a surface of the article may have an obvious defect. The reason could be inappropriate engineering designs, manual mistakes or mechanical errors in the manufacturing process, the deformation or the damage caused by the overloading, or etc. In the conventional art, in order to reform a defect surface of the article, the appearance of the article should be scanned by an extra scanning device to recognize the reforming position, and then the surface of the article is reformed by applying an external force. However, when the article is pressed by applying the external force, the stress of the article will cause the spring back on the surface of the article. In results, the unexpected curving or distortion is generated during reforming process, and the difficulty of reforming is increased and it takes lots of time and work.

Therefore, a surface reforming device which can reduce the reforming time and effect of the spring back is still a pursued target of practitioners.

### SUMMARY

According to one aspect of the present disclosure, a surface reforming device which is configured for reforming a surface of an article includes a frame body, a first shaping assembly, a second shaping assembly and a driving mechanism. The frame body includes two side plates and a supporting shaft. The two side plates are spaced from each other to form an operating space. The supporting shaft is connected between the two side plates and configured for inserting through the article to locate the article at the operating space. The first shaping assembly is located in the operating space and includes a first plate body, a plurality of first through holes, a plurality of first rods and a plurality of first rod locking mechanisms. The first plate body is configured to be moved so as to get close to one of two sides of the article, and the first plate body extends along a z-axis. The first through holes are disposed on the first plate body. Each of the first rods is movably inserted through each of the first through holes, and each of the first rods is configured for abutting against a locating article to move to a first reforming position according to a predetermined surface of the locating article. Each of the first rod locking mechanisms is configured for remanding each of the first rods at each of the first reforming positions. The second shaping assembly is located in the operating space and includes a second plate body, a plurality of second through holes, a plurality of second rods and a plurality of second rod locking mechanisms. The second plate body is configured to be moved so as to get close to another one of two sides of the article, and the second plate body extends along the z-axis. The second through holes are disposed on the second plate body. Each of the second rods is movably inserted through each of the second through holes, and each of the second rods is configured for abutting against the locating article to move to a second reforming position according to the predetermined surface of the locating article. Each of the second rod locking mechanisms is configured for remanding each of the second rods at each of the second reforming positions. The driving mechanism is configured for driving the first shaping assembly and the second shaping assembly to move towards each other along a pushing direction perpendicular to the z-axis and press the article so that the first rods and the second rods push the article for reforming the surface of the article to the predetermined surface of the locating article.

According to another aspect of the present disclosure, a surface reforming method for reforming a surface of an article includes an article locating step, a rod locating step, an article replacing step and a surface reforming step. The article locating step is performed to locate a locating article in an operating space of a surface reforming device. The rod locating step is performed to drive a first shaping assembly and a second shaping assembly of the surface reforming device move towards each other so as to get close to the locating article, so that a plurality of first rods of the first shaping assembly and a plurality of second rods of the second shaping assembly abut against the locating article so as to move to a first reforming position and a second reforming position, respectively, according to a predetermined surface of the locating article, and the rod locating step performed to remand each of the first rods and each of the second rods at the first reforming position and the second reforming position, respectively, and then separate the first shaping assembly and the second shaping assembly from the locating article. The article replacing step is performed to remove the locating article from the operating space and locate the article in the operating space. The surface reforming step is performed to move the first shaping assembly and the second shaping assembly towards each other along a pushing direction, and to allow the first rods and the second rods to push and press the article for reforming the surface of the article to the predetermined surface of the locating article.

### BRIEF DESCRIPTION OF THE DRAWINGS

The present disclosure can be more fully understood by reading the following detailed description of the embodiment, with reference made to the accompanying drawings as follows:

FIG. 1 shows a three-dimensional schematic view of a surface reforming device according to an embodiment of the present disclosure.

FIG. 2 shows a schematic view of the first rods and the second rods of the surface reforming device abutting the locating article according to the embodiment in FIG. 1.

FIG. 3 shows a schematic view of an article installed on the surface reforming device according to the embodiment in FIG. 1.

FIG. 4 shows a step block diagram of a surface reforming method according to another embodiment of the present disclosure.

FIG. 5 shows a flow chart of the surface reforming method in FIG. 4.

### DETAILED DESCRIPTION

It will be understood that when an element (or mechanism or module) is referred to as being “disposed on”, “connected to” or “coupled to” another element, it can be directly disposed on, connected or coupled to the other elements, or it can be indirectly disposed on, connected or coupled to the other elements, that is, intervening elements may be present. In contrast, when an element is referred to as being “directly disposed on”, “directly connected to” or “directly coupled to” another element, there is no intervening element present.

In addition, the terms first, second, third, etc. are used herein to describe various elements or components, these elements or components should not be limited by these terms. Consequently, a first element or component discussed below could be termed a second element or component.

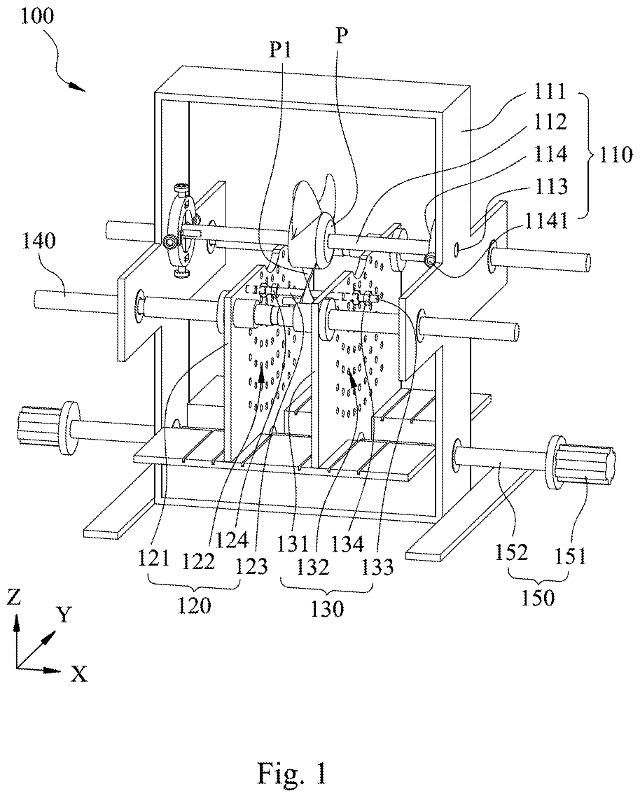

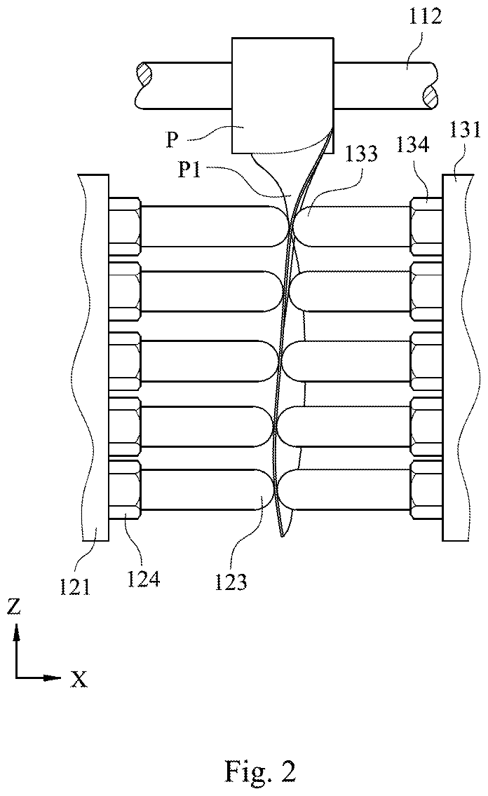

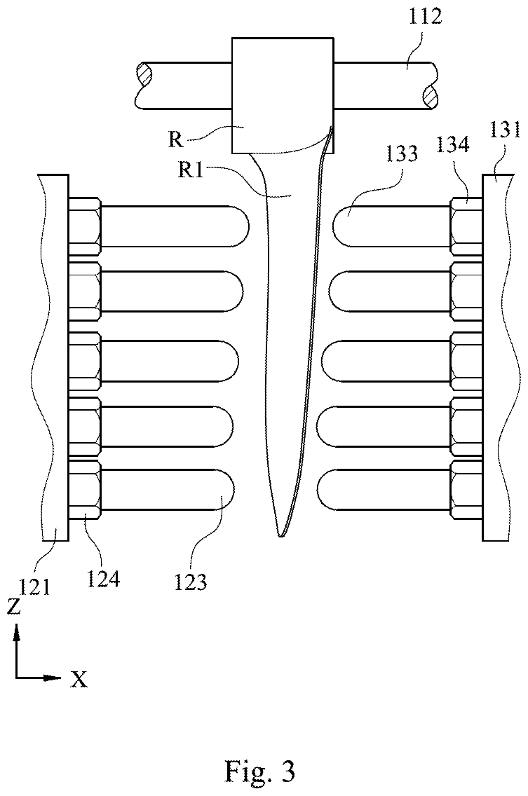

FIG. 1 shows a three-dimensional schematic view of a surface reforming device 100 according to an embodiment of the present disclosure. FIG. 2 shows a schematic view of the first rods 123 and the second rods 133 of the surface reforming device 100 abutting the locating article P according to the embodiment in FIG. 1. FIG. 3 shows a schematic view of an article R installed on the surface reforming device 100 according to the embodiment in FIG. 1. As shown in FIGS. 1-3, the surface reforming device 100 is configured for reforming a surface R1 of an article R, and includes a frame body 110, a first shaping assembly 120, a second shaping assembly 130 and a driving mechanism 150. The frame body 110 includes two side plates 111 and a supporting shaft 112. The two side plates 111 are spaced from each other to form an operating space. The supporting shaft 112 is connected between the two side plates 111 and configured for inserting through the article R to locate the article R at the operating space. The first shaping assembly 120 is located in the operating space and includes a first plate body 121, a plurality of first through holes 122, a plurality of first rods 123 and a plurality of first rod locking mechanisms 124. The first plate body 121 is configured to be moved so as to get close to one of two sides of the article R, and the first plate body 121 extends along a z-axis. The first through holes 122 are disposed on the first plate body 121. Each of the first rods 123 is movably inserted through each of the first through holes 122, and each of the first rods 123 is configured for abutting against a locating article P to move to a first reforming position according to a predetermined surface P1 of the locating article P. Each of the first rod locking mechanisms 124 is configured for remanding each of the first rods 123 at each of the first reforming positions. The second shaping assembly 130 is located in the operating space and includes a second plate body 131, a plurality of second through holes 132, a plurality of second rods 133 and a plurality of second rod locking mechanisms 134. The second plate body 131 is configured to be moved so as to get close to another one of two sides of the article R, and the second plate body 131 extends along the z-axis. The second through holes 132 are disposed on the second plate body 131. Each of the second rods 133 is movably inserted through each of the second through holes 132, and each of the second rods 133 is configured for abutting against the locating article P to move to a second reforming position according to the predetermined surface P1 of the locating article P. Each of the second rod locking mechanisms 134 is configured for remanding each of the second rods 133 at each of the second reforming positions. The driving mechanism 150 is configured for driving the first shaping assembly 120 and the second shaping assembly 130 to move towards each other along a pushing direction perpendicular to the z-axis (that is, a direction parallel to an x-axis) and press the article R so that the first rods 123 and the second rods 133 push the article R for reforming the surface R1 of the article R to the predetermined surface P1 of the locating article P.

It is worth to be specified that the first rods 123 and the second rods 133 in FIG. 1 only illustrate the configuration of the first rods 123 and the first through holes 122 and the configuration of the second rods 133 and the second through holes 132. Numbers of the first rods 123 and the second rods 133 can be adjusted according to the necessary requirements, but the present disclosure is not limited to the number disclosed in drawings.

By positioning the first rods 123 and the second rods 133 according to the predetermined surface P1, the surface R1 of the article R can be reformed without scanned by an extra scanning device and can be reformed with multipoint. Hence, the time period of reforming the surface R1 can be effectively decreased, and the spring back caused by stress on the article R can be reduced so as to improve the efficiency of the surface reforming. The details of the surface reforming device 100 will be described in the followings.

As shown in FIGS. 2 and 3, the first shaping assembly 120 and the second shaping assembly 130 get close to the locating article P inserted by the supporting shaft 112 via the driving mechanism 150 which drives the first plate body 121 and the second plate body 131 to move towards to the locating article P. Therefore, the first rods 123 and the second rods 133 abut against the locating article P. Because each of the first rods 123 and each of the second rods 133 are movably inserted through each of the first through holes 122 and each of the second through hole 132, respectively, each of the first rods 123 and each of the second rods 133 move along the x-axis relatively to the first plate body 121 and the second plate body 131, respectively, during the process that the first plate body 121 and the second plate body 131 get close to the locating article P. In results, each of the first rods 123 and each of the second rods 133 can move to the first reforming position and the second reforming position relative to the first plate body 121 and the second plate body 131, respectively, according to the shape of the predetermined surface P1. Hence, the first rods 123 and the second rods 133 can simulate the shape of the predetermined surface P1 and be configured to be a mold for reforming the surface R1 of the article R. Then, each of the first rod locking mechanisms 124 and each of the second rod locking mechanisms 134 remand each of the first rods 123 and each of the second rods 133 at each of the first and second reforming positions relative to the first plate body 121 and second plate body 131, respectively. Subsequently, the driving mechanism 150 drives the first shaping assembly 120 and the second shaping assembly 130 to move away from the locating article P, and the locating article P is removed from the supporting shaft 112. To be notified that each of the first rod locking mechanisms 124 and each of the second rod locking mechanisms 134 can remand each of the first rods 123 and each of the second rods 133 at each of the first and second reforming positions after the first plate body 121 and the second plate body 131 move away from the locating article P, but the present disclosure is not limited thereto. After the first rods 123 and the second rods 133 simulate the shape of the predetermined surface P1, the article R can be installed on the supporting shaft 112. In the last, the driving mechanism 150 drives the first shaping assembly 120 and the second shaping assembly 130 to press the article R, and thereby the first rods 123 remanded at the first reforming positions and the second rods 133 remanded at the second reforming positions push and press the article R. The driving mechanism 150 can be a hydraulic mechanism and keep the first shaping assembly 120 and the second shaping assembly 130 pressing the article R. The driving mechanism 150 can also drive the first shaping assembly 120 and the second shaping assembly 130 to further press the article R by knocking. Hence, the surface R1 of the article R can be reformed to the predetermined surface P1 of the locating article P.

As shown in FIG. 1, the frame body 110 can further include two pivot holes 113 and two shaft locking mechanisms 114. The two pivot holes 113 are disposed on the two side plates 111, respectively, wherein each of two ends of the supporting shaft 112 is pivotally disposed on each of the two pivot holes 113. The two shaft locking mechanisms 114 are located on the two pivot holes 113, respectively, and the two shaft locking mechanisms 114 are configured for locking the supporting shaft 112 in a locating position. Specifically, each of the two shaft locking mechanisms 114 includes four bolt elements 1141 which are configured for abutting against and locking the supporting shaft 112. Both of the locating article P and the article R are propellers. Take the locating article P as an example, after the locating article P is inserted by the supporting shaft 112, the predetermined surface P1 of one leaf of the locating article P can be rotated by rotating the supporting shaft 112 to a position which can be abutted by the first rods 123 and the second rods 133. Then, the two shaft locking mechanisms 114 lock the supporting shaft 112 in the locating position to remand the position of the locating article P in the operating space; similarly, when the locating article P is removed from the supporting shaft 112 and replaced by the article R, the surface R1 of the leaf of the article R, which is going to be reformed, is rotated and remanded to the same position as the predetermined surface P1 in the operating space by the two shaft locking mechanisms 114. Hence, the accuracy of the position of the article R which is going to be pushed by the first rods 123 and the second rods 133 can be improved. In results, the precision of reforming surface can be improved. To be notified that, in other embodiments, when the article is other kinds of articles, the frame body can exclude the supporting shaft, but include remanding elements such as clamps to remand the article in the operating space.

In efficiency, when the surface R1 of one leaf of the article R is reformed by the conventional art, the reforming time is about 29 mins; when the article R is reformed by the present disclosure, the maximum reforming time is about 3 mins. Compared with the conventional arts, the reforming time can be largely reduced by the present disclosure.

Moreover, the frame body 110 can further include two supporting rods 140. Each of the two supporting rods 140 is connected between the two side plates 111 and penetrates through the first plate body 121 and the second plate body 131 in order. The driving mechanism 150 can include two motors 151 and two stretchable driving rods 152. One of the motors 151 drives one of the stretchable driving rods 152 to push the first shaping assembly 120, and the other one of the motors 151 drives the other one of the stretchable driving rods 152 to push the second shaping assembly 130. In detail, the driving mechanism 150 is a hydraulic linear actuator which has the function of extending by hydraulic mechanics, but the present disclosure is not limited thereto. The driving mechanism 150 is configured for pushing the first shaping assembly 120 and the second shaping assembly 130 to move closely to each other or to move away from each other. Hence, the first shaping assembly 120 and the second shaping assembly 130 can be remained still along the z-axis and a y-axis and move towards each other along the pushing direction parallel to the x-axis. In other embodiments, the driving mechanism can drive the first shaping assembly and the second shaping assembly by air-hydraulic or screw threaded driving. In other words, the driving mechanism can be a pneumatic cylinder, a screw threaded linear actuator, or etc. Or, the first shaping assembly and the second shaping assembly can be pushed manually without any driving mechanics, and the present disclosure is not limited to the aforementioned methods.

In specific, each of the first rods 123 and the second rods 133 can be made of aluminum material. Each of the first rod locking mechanisms 124 and the second rod locking mechanisms 134 can be a nut element, and each of the first rods 123 and the second rods 133 has the corresponding screw thread, so that each of the first rod locking mechanisms 124 and each of the second rod locking mechanisms 134 can be configured for remanding each of the first rods 123 and each of the second rods 133 at each of the first reforming positions and each of the second reforming positions, respectively. In other embodiments, the surface reforming device can include a heating mechanism which is configured for heating the first rods and the second rods. By the first rods and the second rods pushing the article with high temperature, the surface of the article can be heated, and formability thereof can be improved. Hence, the efficiency of surface reforming can be further improved.

As shown in FIG. 1, each shape that the first through holes 122 and second through holes 132 are arranged is substantially fan-shaped. The arrangement of the first through holes 122 and second through holes 132 can match the projected shape of the predetermined surface P1 of one leaf of the locating article P, which is projected on a plane of z- and y-axes so as to increase the simulation fidelity of the predetermined surface P1 simulated by the first rods 123 and the second rods 133. Hence, the arrangement of the through holes of the shaping assembly can be adjusted according to the surface R1 of the article R to improve the accuracy of the first rods 123 and the second rods 133 pushing the article R.

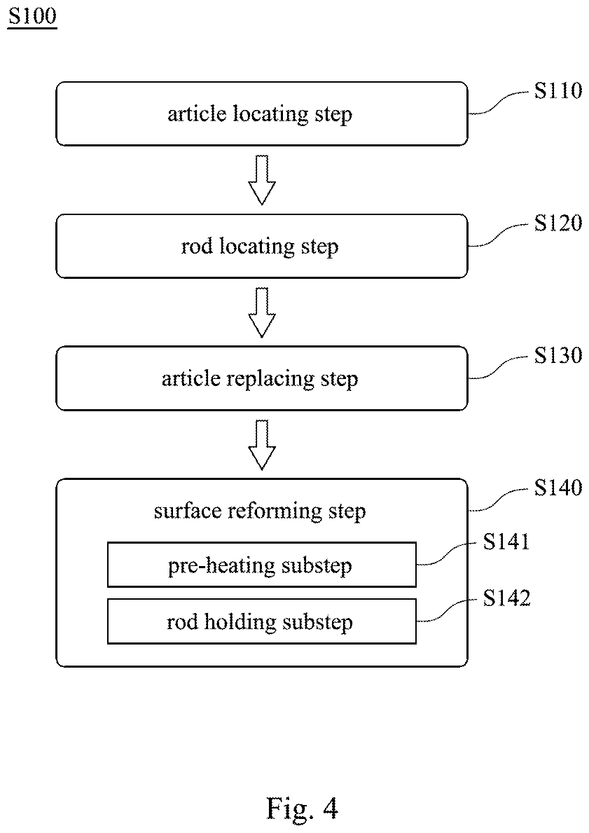

FIG. 4 shows a step block diagram of a surface reforming method S100 according to another embodiment of the present disclosure. In the following, the surface reforming method S100 is illustrated with the surface reforming device 100 in FIGS. 1 to 3, but the present disclosure is not limited thereto. The surface reforming method S100 is for reforming a surface R1 of an article R and includes an article locating step S110, a rod locating step S120, an article replacing step S130 and a surface reforming step S140. The article locating step S110 is performed to locate a locating article P in an operating space of a surface reforming device 100. The rod locating step S120 is performed to drive a first shaping assembly 120 and a second shaping assembly 130 of the surface reforming device 100 move towards each other so as to get close to the locating article P, so that a plurality of first rods 123 of the first shaping assembly 120 and a plurality of second rods 133 of the second shaping assembly 130 abut against the locating article P so as to move to a first reforming position and a second reforming position, respectively, according to a predetermined surface P1 of the locating article P, and the rod locating step S120 is then performed to remand each of the first rods 123 and each of the second rods 133 at the first reforming position and the second reforming position, respectively, and then separate the first shaping assembly 120 and the second shaping assembly 130 from the locating article P. The article replacing step S130 is performed to remove the locating article P from the operating space and locate the article R in the operating space. The surface reforming step S140 is performed to move the first shaping assembly 120 and the second shaping assembly 130 towards each other along a pushing direction, and to allows the first rods 123 and the second rods 133 to push and press the article R for reforming the surface R1 of the article R to the predetermined surface P1 of the locating article P.

The surface R1 of the article R can be reformed by the first rods 123 and the second rods 133 which are positioned according to the predetermined surface P1. Hence, the reforming time of reforming the surface R1 can be reduced effectively, and the spring back caused by stress on the article R can be reduced. Therefore, the efficiency of surface reforming can be improved.

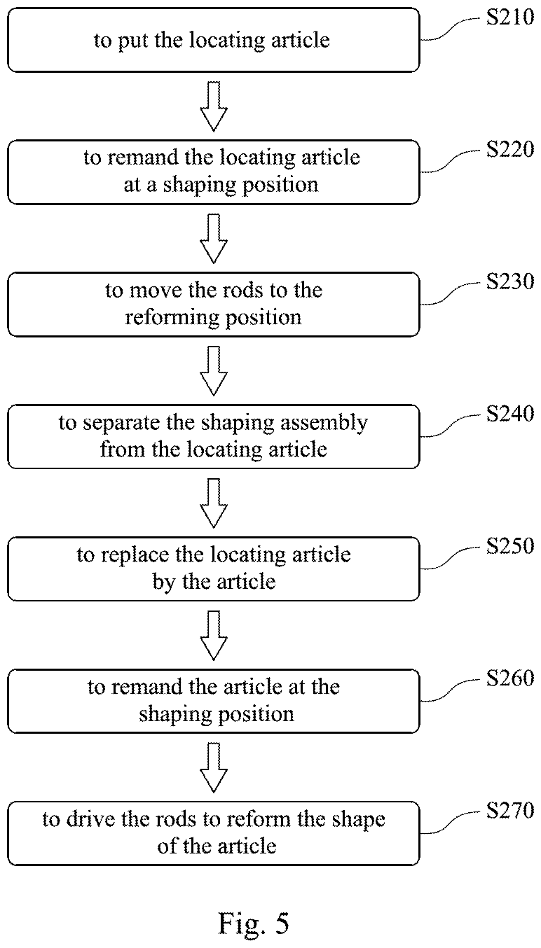

FIG. 5 shows a flow chart of the surface reforming method S100 in FIG. 4. As shown in FIG. 5, the surface reforming method S100 includes steps S210, S220, S230, S240, S250, S260, S270. In the step S210, the locating article P is put in the operating space and inserted by the supporting shaft 112, and then the step S220 is performed. In the step S220, the predetermined surface P1 of one leaf of the locating article P is rotated to a position which can be abutted by the first rods 123 and the second rods 133 by rotating the supporting shaft 112, the two shaft locking mechanisms 114 lock the supporting shaft 112 in the locating position to remand the position of the locating article P in the operating space, and then the step S230 is performed. In the step S230, by driving the driving mechanism 150 or manually driving, the first shaping assembly 120 and the second shaping assembly 130 move towards each other and abut against the locating article P so that each of the first rods 123 and each of the second rods 133 move to a first reforming position and a second reforming position, respectively. Each of a plurality of first rod locking mechanisms 124 and each of a plurality of second rod locking mechanisms 134 remand each of the first rods 123 and each of the second rods 133, and the step S240 is performed. In the step S240, the first shaping assembly 120 and the second shaping assembly 130 are driven by the driving mechanism 150 or manually to move away from each other and separate from the locating article P, and the step S250 is performed. In the step S250, the locating article P is removed from the supporting shaft 112, the article R is installed on the supporting shaft 112, and the step S260 is performed. In the step S260, the leaf of the article R, which is going to be reformed, is moved to the same position as the leaf of the locating article P in the step S220 by rotating the supporting shaft 112 and then remanded by the two shaft locking mechanisms 114 locking the supporting shaft 112, and then the step S270 is performed. In the step S270, the first shaping assembly 120 and the second shaping assembly 130 are driven by the driving mechanism 150 or manually to move towards each other along the pushing direction, and the first rods 123 and the second rods 133 are allowed to push and press the article R for reforming the surface R1 of the article R to the predetermined surface P1 of the locating article P.

Please refer to FIG. 4, the surface reforming step S140 can include a pre-heating substep S141. The pre-heating substep S141 is performed to heat the first rods 123 and the second rods 133. Furthermore, the first rods 123 and the second rods 133 can be quenched first, and then push and press the article R. By the first rods 123 and the second rods 133 pushing the article R with high temperature, the surface R1 of the article R can be heated, and formability of the surface R1 can be improved. Hence, the efficiency of surface reforming can be further improved. In detail, the pre-heating substep S141 can be executed before the step S270, or executed in the step S270, but the present disclosure is not limited thereto.

The surface reforming step S140 can further include a rod holding substep S142. The rod holding substep S142 is performed to hold the first shaping assembly 120 and the second shaping assembly 130 at an abutting position in a holding period when the first rods 123 and the second rods 133 abut against the article R, and then separate the first rods 123 and the second rods 133 from the article R. In detail, the abutting position is a position of the first shaping assembly 120 and the second shaping assembly 130 when the first plate body 121 and the second plate body 131 move towards each other and push the article R for forming the surface R1 of the article R. By remaining the first rods 123 and the second rods 133 abutting against the article R for a time period, the elasticity of the article R can be changed and the spring back caused by stress can be reduced. In detail, in the step S270, the rod holding substep S142 can be performed for holding the first rods 123 and the second rods 133. Moreover, the rod holding substep S142 and the pre-heating substep S141 can be executed at the same time, but the present disclosure is not limited thereto.

In summary, the present disclosure has the following advantages: first, by remanding the first rods and the second rods according to the predetermined surface, an extra scanning device is not needed so that the cost can reduced and the efficiency of reforming can be improved; second, by heating the first rods and the second rods, the efficiency of the surface reforming can be further improved; third, by holding the first rods and the second rods in a time period, the spring back caused by stress can be reduced.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. A surface reforming device, configured for reforming a surface of an article, and the surface reforming device comprising:
a frame body comprising:
two side plates spaced from each other to form an operating space; and
a supporting shaft connected between the two side plates, and configured for inserting through the article to locate the article at the operating space;
a first shaping assembly located in the operating space, and comprising:
a first plate body configured to be moved so as to get close to one of two sides of the article, and the first plate body extending along a z-axis;
a plurality of first through holes disposed on the first plate body;
a plurality of first rods, wherein each of the first rods is movably inserted through each of the first through holes, and each of the first rods is configured for abutting against a locating article to move to a first reforming position according to a predetermined surface of the locating article; and
a plurality of first rod locking mechanisms, each of the first rod locking mechanisms configured for remanding each of the first rods at each of the first reforming positions;
a second shaping assembly located in the operating space, and comprising:
a second plate body configured to be moved so as to get close to another one of the two sides of the article, and the second plate body extending along the z-axis;
a plurality of second through holes disposed on the second plate body;
a plurality of second rods, wherein each of the second rods is movably inserted through each of the second through holes, and each of the second rods is configured for abutting against the locating article to move to a second reforming position according to the predetermined surface of the locating article; and
a plurality of second rod locking mechanisms, each of the second rod locking mechanisms configured for remanding each of the second rods at each of the second reforming positions; and
a driving mechanism configured for driving the first shaping assembly and the second shaping assembly to move towards each other along a pushing direction perpendicular to the z-axis and press the article so that the first rods and the second rods push the article for reforming the surface of the article to the predetermined surface of the locating article.

2. The surface reforming device of claim 1, further comprising two supporting rods, each of the two supporting rods connected between the two side plates and penetrating through the first plate body and the second plate body in order, wherein the driving mechanism comprises two stretchable driving rods, and each of the two stretchable driving rods is configured to be extend and push the first shaping assembly and the second shaping assembly to move towards each other along the pushing direction.

3. The surface reforming device of claim 1, wherein each of the first rods and the second rods is made of aluminum material.

4. The surface reforming device of claim 1, further comprising:
a heating mechanism configured for heating the first rods and the second rods.

5. The surface reforming device of claim 1, wherein the frame body further comprises:
two pivot holes disposed on the two side plates, respectively, wherein each of two ends of the supporting shaft is pivotally disposed on each of the two pivot holes; and
two shaft locking mechanisms located on the two pivot holes, respectively, and the two shaft locking mechanisms configured for locking the supporting shaft in a locating position.

6. The surface reforming device of claim 1, wherein each shape that the first through holes and second through holes arranged is substantially fan-shaped.

7. A surface reforming method for reforming a surface of an article, comprising:
an article locating step performed to locate a locating article in an operating space of a surface reforming device;
a rod locating step performed to drive a first shaping assembly and a second shaping assembly of the surface reforming device move towards each other so as to get close to the locating article, so that a plurality of first rods of the first shaping assembly and a plurality of second rods of the second shaping assembly abut against the locating article so as to move to a first reforming position and a second reforming position, respectively, according to a predetermined surface of the locating article, and the rod locating step performed to remand each of the first rods and each of the second rods at the first reforming position and the second reforming position, respectively, and then separate the first shaping assembly and the second shaping assembly from the locating article;
an article replacing step performed to remove the locating article from the operating space and locate the article in the operating space; and
a surface reforming step performed to move the first shaping assembly and the second shaping assembly towards each other along a pushing direction, and to allow the first rods and the second rods to push and press the article for reforming the surface of the article to the predetermined surface of the locating article.

8. The surface reforming method of claim 7, wherein the surface reforming step comprises:
a pre-heating substep performed to heat the first rods and the second rods.

9. The surface reforming method of claim 7, wherein the surface reforming step comprises:
a rod holding substep performed to hold the first shaping assembly and the second shaping assembly at an abutting position in a holding period when the first rods and the second rods abut against the article, and then separate the first rods and the second rods from the article.
